(19) United States
(12) Patent Application Publication
(10) Pub. No.: US 2024/0240704 A1
(43) Pub. Date: Jul. 18, 2024

(54) NON-BACKLASH GEAR DRIVE MECHANISM

(71) Applicant: Suzhou Xunshida Technology Co., Ltd, Suzhou (CN)

(72) Inventor: Lian Duan, Suzhou (CN)

(21) Appl. No.: 18/453,653

(22) Filed: Aug. 22, 2023

(30) Foreign Application Priority Data
Jan. 13, 2023 (CN) 2023200833876

(51) Int. Cl. F16H 55/24; F16H 1/16

(52) U.S. Cl. CPC F16H 55/24; F16H 1/16

(57) ABSTRACT

Non-backlash gear drive mechanism consists of a housing part, a first gear, a second gear, a spring component, and a self-aligning bearing. The housing part contains a central shaft, a bearing mounting hole, and a limiting hole. By utilizing the automatic aligning characteristic of the self-aligning bearing and the elastic compression force of the spring component, it can eliminate and compensate for deviations during processing and assembly that may cause excessive backlash or gears to become stuck during transmission. As a result, this non-backlash gear transmission mechanism is particularly suited for gear drive applications with a light load, low rotational speed, frequent direction reversal, and requiring backlash elimination.

### 1. TECHNICAL FIELD

This invention relates to the field of gear drive mechanisms. Specifically, this invention relates to a gear drive mechanism that operates with a light load, rotates at low speeds, and frequently reversing direction, requiring a non-backlash transmission.

### 2. BACKGROUND ART

Gear drives have a wide range of power-transmission applications in almost all types of machinery. The major gear types include spur, helical, bevel, and worm gear sets.

The gear drive mechanism, which is made up of two gears, typically uses a fixative method in which the first gear is centrally rotatable, the second gear is fixed with bearings at both ends and engaged with the first gear (as illustrated in FIG. 2). In a gear drive mechanism, a certain amount of backlash is necessary to prevent the intermeshing gears from becoming stuck or damaged due to eccentricity resulting from cumulative deviations in parts machining and assembly. Backlash is a disadvantage since it negatively impacts position angle control accuracy, especially for precision instruments that require frequent reversing direction. As a result, minimizing or eliminating gear backlash in the gear drive mechanism is a major concern.

To reduce backlash, improve machining accuracy of parts, add adjustable elements, and consider using electronic control. However, this may increase production costs.

The plastic gear is designed to create elastic deformation for achieving non-backlash gear drive. Yet, plastic materials decrease the application range and lifespan of a gear drive mechanism.

### 3. SUMMARY OF THE INVENTION

This invention offers a gear drive mechanism that eliminates backlash. It consists of a housing part, a first gear, a second gear, a spring component, and a self-aligning bearing. The housing part includes a central shaft, a bearing mounting hole, and a limiting hole. The first gear is rotatably centered on the central shaft of the housing part. the second gear is rotatably mounted on the housing part and engaged with the first gear.

Furthermore, one end of the second gear is securely slidden into the self-aligning bearing, which is in turn securely mounted into the bearing mounting hole of the housing part. The other end of the second gear is rotatably slidden through a limiting hole in the housing part. Utilizing the automatic aligning characteristic of the self-aligning bearing, the second gear shaft can oscillate about a pivot axis of the self-aligning bearing. At the same time, the oscillation direction and range of motion of the second gear shaft is restricted by the design of the limiting hole in the housing part; the second gear can only oscillate forwards or backwards, along the radial direction, relative to the first gear. Therefore, the first gear and the second gear remain constantly engaged.

Moreover, the spring component is positioned on the housing part and held to biased against the second gear through its elastic force. Consequently, the second gear is biased towards the first gear simultaneously. The elastic compressive force eliminates and compensates for any deviations caused by processing and assembly, which lead to excessive backlash or gears being stuck during transmission. Thus, this achieves a non-backlash gear transmission.

Moreover, the position of the spring component on the housing part can be adjusted, thereby being adjusted the load of elastic force biased against the second gear. As a result, the load of elastic compression force between the first gear and second gear can be adjusted. This enables smooth and non-backlash gear transmission to be achieved.

This invention has advantages over existing methods of eliminating backlash. Namely, it is suitable for gears made of all materials. It simultaneously eliminates backlash and prevents gears from getting stuck. This method reduces production costs and does not require additional machining accuracy or assembly space. This method is ideal for gear drive mechanisms that operate with light loads, low rotational speeds, and frequent reversing, and where elimination of backlash is necessary.

### 4. BRIEF DESCRIPTION OF ACCOMPANY DRAWINGS

FIG. 1 is a sectional view of the non-backlash gear drive mechanism according to the invention.

FIG. 2 is a sectional view of a conventional gear drive mechanism.

FIG. 3 is a front view of the limiting hole of the non-backlash gear drive mechanism according to the invention.

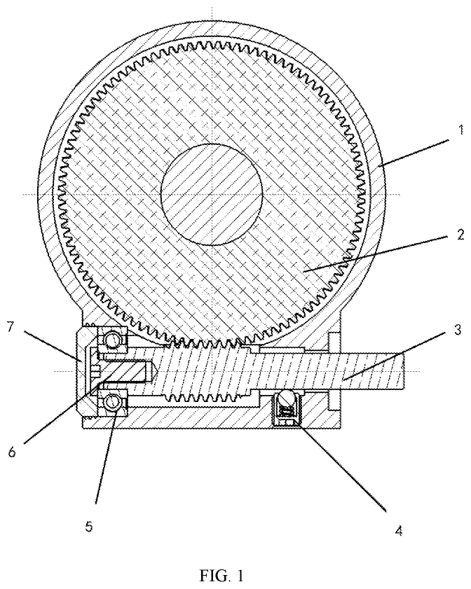

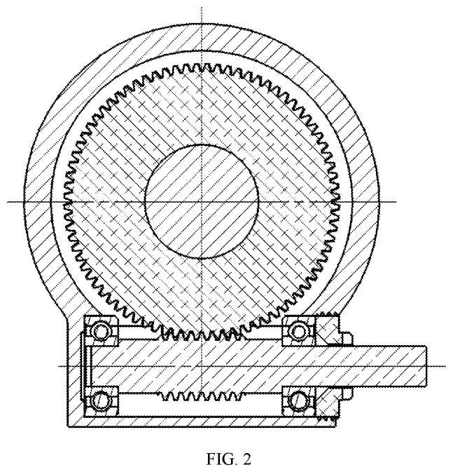

In FIGS. 1-3, 1 refers to the housing part; 2 refers to the worm gear; 3 refers to the worm shaft; 4 refers to the spring component; 5 refers to the self-aligning bearing; 6 refers to the screw; 7 refers to the screw cap.

### 5. SPECIFIC EMBODIMENT OF THE INVENTION

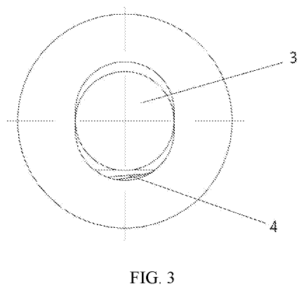

The purpose of this invention is to provide a gear drive mechanism that is free of backlash, therefore solving the aforementioned disadvantages caused by backlash. The technical solutions for the embodiments of this invention will be explained in this document, with the help of references to FIGS. 1 and 3.

FIG. 1 shows a non-backlash gear drive mechanism includes the following parts: a housing part 1, a worm gear 2, a worm shaft 3, a spring component 4, a self-aligning bearing 5, a screw 6, and a screw cap 7. The housing part contains a central shaft, a bearing mounting hole, and a limiting hole. (As presented in FIG. 3). The center of the worm gear 2 is rotatably centered on the central shaft of the housing part 1. The worm shaft 3 is rotatably mounted on the housing part 1 and engaged with the worm gear 2.

One end of worm shaft 3 is rotatably slidden into the self-aligning bearing 5 and secured with the screw 6, The self-aligning bearing 5 mounted into the bearing mounting hole of the housing part 1 and secured with the screw cap 7. The other end of the worm shaft 3 is rotatably slidden through a limiting hole of the housing part 1. Utilizing the automatic aligning characteristic of the self-aligning bearing 5, the worm shaft 3 can oscillate about a pivot axis of the self-aligning bearing 5. At the same time, the oscillation direction and range of motion of the worm shaft 3 is restricted by the design of the limiting hole in the housing part 1; the worm shaft 3 can only oscillate forwards or backwards, along the radial direction, relative to the worm gear 2. Therefore, the worm gear 2 and worm shaft 3 remain constantly engaged.

The spring component 4 is positioned on the housing part 1 and held to biased against the worm shaft 3 through its elastic force. Consequently, the worm shaft 3 is biased towards engagement with the worm gear 2 simultaneously. The elastic compressive force eliminates and compensates for any deviations caused by processing and assembly, which lead to excessive backlash or gears being stuck during transmission. Thus, this achieves a non-backlash gear transmission.

The position of the spring component 4 on the housing part 1 can be adjusted, thereby being adjusted the load of the elastic force biased against the worm shaft 3. As a result, the load of elastic compression force between the worm gear 2 and worm shaft 3 can be adjusted. This enables smooth and non-backlash gear transmission to be achieved.

The invention creatively utilizes the automatic aligning characteristics of the self-aligning bearing 5, the limiting hole of the housing part 1, and the spring component 4 which provides the elastic compression force. During transmission, all deviations caused by processing and assembly that may lead to excessive backlash or gear sticking are compensated and eliminated. This results in a non-backlash gear transmission, providing accurate position angle control. This is especially useful for precision instruments that operate at low speeds, with a light load and frequently reversing directions.

The embodiments of the invention have been described and shown. However, it should be noted that for those with ordinary skills in the field, various alterations, modifications, and substitutions can be made to these embodiments without violating the principle and spirit of the invention. The protection scope of the invention is defined by the appended claims along with their equivalents.

1. The non-backlash gear drive mechanism consists of a housing part, a first gear, a second gear, a spring component, and a self-aligning bearing; the housing part includes a central shaft, a bearing mounting hole, and a limiting hole, the first gear is rotatably centered on the central shaft of the housing part, the second gear is rotatably mounted on the housing part and engaged with the first gear;
one end of the second gear is securely slidden into the self-aligning bearing, which is in turn securely mounted into the bearing mounting hole of the housing part, the other end of the second gear is rotatably slidden through a limiting hole in the housing part, utilizing the automatic aligning characteristic of the self-aligning bearing, the second gear shaft can oscillate about a pivot axis of the self-aligning bearing, at the same time, the oscillation direction and range of motion of the second gear shaft is restricted by the design of the limiting hole in the housing part; the second gear can only oscillate forwards or backwards, along the radial direction, relative to the first gear; the first gear and the second gear remain constantly engaged;
the spring component is positioned on the housing part and held to biased against the second gear through its elastic force, the second gear is biased towards the first gear simultaneously, the elastic compressive force eliminates and compensates for any deviations caused by processing and assembly, which lead to excessive backlash or gears being stuck during transmission, this achieves a non-backlash gear transmission;
the position of the spring component on the housing part can be adjusted, thereby being adjusted the load of elastic force biased against the second gear, the load of elastic compression force between the first gear and second gear can be adjusted to enable smooth and non-backlash gear transmission to be achieved.

2. The non-backlash gear drive mechanism of claim 1, wherein the non-backlash gear drive mechanism has a pair of gears, consisting of the first gear and the second gear, in which the first gear may be a worm gear, spur gear or helical gear.

3. The non-backlash gear drive mechanism of claim 1, wherein the first gear and second gear form a gear pair, the second gear can be a worm shaft, spur gear, or helical gear, depending on the type of the first gear.

4. The non-backlash gear drive mechanism of claim 1, wherein includes a self-aligning bearing that could be a joint bearing or a component, which is designed to rotate axially and oscillate.
